(19) United States
(12) Patent Application Publication
(10) Pub. No.: US 2026/0003675 A1
(43) Pub. Date: Jan. 1, 2026

(54) RESOURCE UTILIZATION OF A PROCESSING UNIT

(71) Applicant: Microsoft Technology Licensing, LLC, Redmond, WA (US)

(72) Inventors: Zhenhua HAN, Shanghai (CN); Peng CHENG, Redmond, WA (US); Fan YANG, Beijing (CN); Ran SHU, Beijing (CN); Yuqing YANG, Shanghai (CN); Wei ZHANG, Redmond, WA (US)

(21) Appl. No.: 18/881,727

(22) PCT Filed: Jun. 7, 2023
(86) PCT No.: PCT/US2023/024633

§ 371 Date: Jan. 6, 2025

(30) Foreign Application Priority Data
Jul. 8, 2022 (CN) 202210806930.0

(51) Int. Cl. G06F 9/48

(52) U.S. Cl. CPC G06F 9/4887; G06F 2209/5019

(57) ABSTRACT

According to implementations of the present disclosure, there is provided a solution for resource utilization of a processing unit. According to the solution, a first period of time for a processing unit is determined at least based on instant execution information of a task of a first service, during the first period of time execution of the task of the first service is suspended on the processing unit. At least based on a predicted execution duration of a task of a second service, at least one task of the second service that is to be completed within the first period of time is selected. The at least one task of the second service is scheduled to be executed by the processing unit within the first period of time. In this way, resources of the processing unit can be fully utilized, and the resource utilization is improved.

### BACKGROUND

Some compute-intensive services utilize dedicated processing units, such as graphics processing units (GPUs), to execute various tasks of the services. Dedicated processing units can achieve higher computational efficiency than traditional general-purpose processing units, such as central processing units (CPUs). With the advancement of technology, the computing power of the processing unit gets stronger and stronger. During the operation of some services, the processing unit may be in a low utilization state. Therefore, it is desirable to increase the utilization of processing units as much as possible.

### SUMMARY

According to implementations of the subject matter described herein, there is proposed a solution for improving resource utilization of a processing unit. In various implementations, a first period of time for a processing unit is determined at least based on instant execution information of a task of a first service, during the first period of time execution of the task of the first service is suspended on the processing unit. At least based on a predicted execution duration of a task of a second service, at least one task of the second service that is to be completed within the first period of time is selected. The at least one task of the second service is scheduled to be executed by the processing unit within the first period of time. In this way, resources of the processing unit can be fully utilized, and the resource utilization is improved.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an example environment in which various implementations of the subject matter described herein can be implemented;

FIG. 2 illustrates a schematic block diagram of example architecture in accordance with some implementations of the subject matter described herein;

FIG. 3A illustrates an example of occupancy of resource of a processing unit when separately running a task of a first service;

FIG. 3B illustrates an example of occupancy of resource for co-deployment of multiple services on a processing unit;

FIG. 4 illustrates an example of a memory for storing parameter values in accordance with some implementations of the subject matter described herein;

FIG. 5 illustrates a flowchart of a procedure for resource management in accordance with some implementations of the subject matter described herein; and

FIG. 6 illustrates a schematic block diagram of an electronic device in which various implementations of the subject matter described herein can be implemented.

Throughout the drawings, the same or similar reference symbols refer to the same or similar elements.

### DETAILED DESCRIPTION OF EMBODIMENTS

Principles of the subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter described herein.

As used herein, the term “includes” and its variants are to be read as open terms that mean “includes but is not limited to.” The term “based on” is to be read as “based at least in part on.”

The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

It is to be understood that data involved in the subject matter described herein (including but not limited to the data itself, the acquisition or use of the data) should comply with requirements of corresponding laws and regulations and relevant rules.

It is to be understood that before applying the technical solutions disclosed in various implementations of the subject matter described herein, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may be able to decide on his/her own whether to provide the personal information to the software or hardware, such as electronic devices, applications, servers, or storage media that perform operations of the technical solutions of the subject matter described herein.

As an optional but non-limiting implementation, in response to receiving an active request from the user, the way of sending the prompt information to the user may, for example, include a pop-up window, and the prompt information may be presented in the form of text in the pop-up window.

In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the subject matter descried herein. Other methods that satisfy relevant laws and regulations are also applicable to the implementations of the present disclosure.

As used herein, the term “model” may learn an association between corresponding input and output from training data, and thus a corresponding output may be generated for a given input after the training. The generation of the model may be based on machine learning techniques.

Deep learning (DL) is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

Generally, machine learning may include three stages, i.e., a training stage, a test stage, and an application stage (also referred to as an interference stage). In the training stage, a given model may be trained using a great amount of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, a test input is applied to the trained model to test whether the model can provide a correct output, so as to determine the performance of the model. In the interference stage, the model may be used to process an actual input based on the parameter values obtained in the training and to determine the corresponding output.

### Example Environment

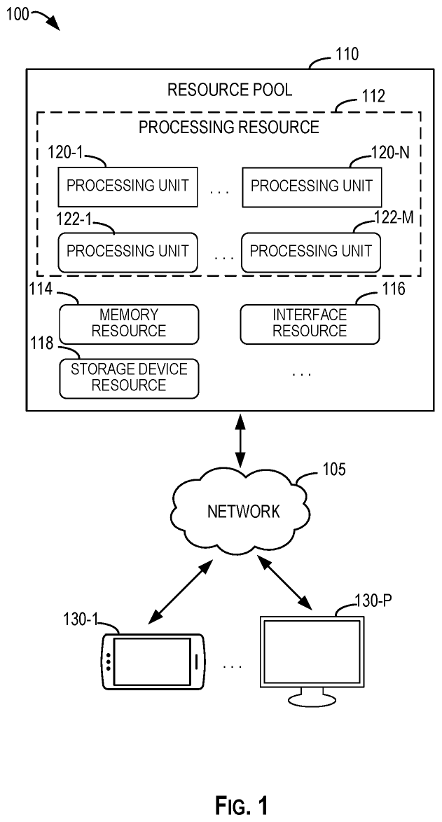

FIG. 1 illustrates a block diagram of an example environment 100 in which a plurality of implementations of the subject matter described herein can be implemented. In the environment 100, a resource pool 110 comprises various types of resources so as to support the execution of services.

As shown, the resource pool 110 comprises processing resources 112, which comprise one or more types of processing units, e.g., a first type of one or more processing units 120-1, . . . , 120-N (collectively or separately referred to as a processing unit(s) 120 for the sake of discussion), a second type of one or more processing units 122-1, . . . , 122-M (collectively or separately referred to as processing units 122 for the sake of discussion).

Different types of processing resources may be configured to have different functions, and, in some cases, may work in collaboration. As an example, the processing units 120 may comprise general-purpose processing units, such as CPUs. The processing units 122 may comprise dedicated processing units, such as GPUs, application-specific integrated circuits (ASICs), field programmable gate arrays (FPGAs), etc. In some examples, the processing units 122 may be configured to execute corresponding processing operations under the control of the processing units 120.

Besides the processing resources, the resource pool 110 may further comprise memory resources 114, interface resources 116, storage device resources 118, etc. The memory resources 114 may comprise kinds of volatile memories and non-volatile memories. The interface resources 116 may comprise interfaces for supporting data exchange and signaling between various components within the resource pool, such as peripheral component interconnect express (PCIe) interfaces, universal serial bus (USB) interfaces, serial advanced technology attachment (SATA) interfaces.

The storage device resources 118 may comprise devices for providing persistent storage of data, such as various types of disks (solid-state drives, disk arrays, etc.).

It is to be understood that some types of resources, though shown separately, may be located in the same physical device.

The service may be scheduled to or deployed in the resource pool 110 to be executed. As an example, the resource pool 110 may comprise a cloud environment in which resources may be allocated for provisioning one or more services. The service herein may be any type of service, application or function, which may be provided by a resource in the resource pool 110. The service may comprise one or more tasks to be executed, each of which corresponds to a fine-grained job of the service.

In some implementations, the operation of the service or the execution of one or more tasks in the service may be triggered based on a client device (e.g., client devices 130-1, . . . , 130-P). These client devices (collectively or separately referred to as client devices 130 for the sake of discussion) may, for example, communicate with the resource pool 110 via a network 105 (such as the Internet) so as to send instructions and data to the resource pool 110 and obtain execution results of tasks therefrom.

It is to be understood that the components and arrangement of the computing device shown in FIG. 1 is merely exemplary, and a computing device that is applicable to implement example implementations of the subject matter described herein may comprise one or more components, other components and/or different arrangement patterns.

### Work Principle and Example Implementations

In some scenarios, when using resource pools to provide certain services, a problem may arise that the resource utilization, especially the resource utilization of processing resources is low. For example, the task processing of some services requires high requirements on quality of service, high randomness, unpredictability and the like. Thus, in order to meet the requirements of the quality of service, dedicated processing resources need to be allocated to execute tasks of these services. However, since the occurrence of tasks of these services is random and unpredictable, processing resources will be idle within some periods of time. As an example, cloud gaming services have gradually emerged in recent years. Different from the traditional practice of downloading and running game applications locally on the user's client device, cloud gaming services run in a remote resource pool so as to utilize the more powerful processing resources in the resource pool to provide good visual effects of game video streams. For example, the processing unit may be configured to execute frame rendering tasks for game video streams. The remote deployment of cloud gaming services can greatly reduce the hardware requirements for client devices. Current cloud gaming platforms allocate dedicated resources for users to run games requested by users, so as to ensure good user experience.

However, due to the limitations of the network, encoding and decoding capabilities, and resolution of client devices, the video streaming quality which high-performance processing units can provide might be far higher than that supported by client devices. It is found through investigation that client devices currently used by most users support resolution rates less than 1080p, and most of frame rates of video streams are at the level of 60 frames per second (FPS). However, the frame rendering processing of video streams supported by the computing power of processing units is far higher than such frame rate requirements. The statistics on resource utilization show that some processing units have a utilization about 50% and even lower. The low utilization of processing units will cause problems such as resource waste, increase of the operation and maintenance cost and the like. Therefore, it is desirable to improve the utilization of processing units.

To improve the utilization, one solution is to deploy multiple cloud gaming services in the same processing unit. However, task processing requirements in cloud gaming services have high randomness, unpredictability, interaction and other characteristics. Cloud gaming services' utilization of different resources varies greatly across different time and frames. For example, it usually takes a longer time to process complex frames with rich contents and details, and vice versa. Such variation causes the occupancy of processing resources to fluctuate greatly over time. However, the processing time of frames is difficult to predict due to the random interaction between players and changing game scenes. Moreover, cloud gaming services also exhibit very diverse resource usage patterns, further increasing the degree of unpredictability. If tasks of different cloud gaming services are processed by using the same processing unit, the resource utilization of instant processing units is still low, serious interference will still be caused, and the quality of service of games will be reduced. In addition to cloud gaming services, some other services also exhibit similar characteristics. For example, in streaming media service scenarios such as audio/video live broadcast, audio/video conference, etc., the remote resource pool can also be used to process streaming media frames and send rendered frames to client devices through the network for presentation. In such applications, the processing capability which remote processing units can achieve is usually greater than the quality of service supported by client devices and the network, resulting in the low utilization of processing resources. In addition, due to the randomness of scene complexity, the processing time of each frame varies, which brings about the randomness and unpredictability of task processing requirements of services.

To improve the utilization of processing units while not interfering with some services with high requirements on quality of service, example implementations of the subject matter described herein propose an improved solution to increase the resource utilization of processing units. According to various implementations, tasks of at least two services are executed by using the processing unit. For a first service, an idle period of time for the processing unit is determined at least based on instant execution information of a task of the first service, during which execution of the task of the first service is suspended on the processing unit. A task of a second service of another type is predictable, e.g., at least a predicted execution duration of the task of the second service can be determined. At least based on the predicted execution duration of the task of the second service, at least one task of the second service that is to be completed within the selected idle period of time is selected. The selected at least one task is scheduled to be executed by the processing unit.

In this way, resources of the processing unit can be sufficiently utilized. Moreover, since the idle period of time of the processing unit is determined based on the instant execution information of the first service, and the task of the second service that is to be completed within the idle period of time is scheduled, interference to the first service may be avoided, the processing unit may be prevented from being occupied by other service when the first service has task processing requirements, and the quality of service may be guaranteed for the first service.

Some example implementations of the subject matter described herein will be described in more detail with reference to the drawings.

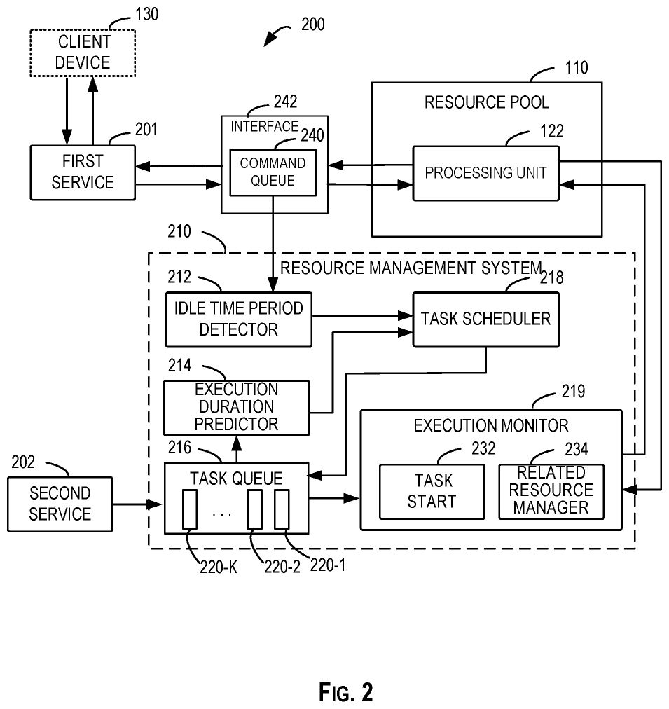

FIG. 2 illustrates a schematic block diagram of example architecture 200 according to some implementations of the subject matter described herein. As shown, the architecture comprises a resource management system 210, which is configured to manage one or more types of resources in the resource pool 110, especially managing resources of the processing unit 122 of the processing resource 112.

Although FIG. 2 merely illustrates a single processing unit 122, it is to be understood that the resource management system 120 may be configured to manage multiple processing units 122 in a similar way. In some implementations, as to be discussed below, the resource management system 210 is configured to manage other processing resources in the resource pool 110, e.g., resources of the processing unit 120 and/or of other type, such as the memory resource 114, the interface resource 116, the storage device resource 118, etc.

The resource management system 210 comprises an idle time period detector 212, an execution duration predictor 214, a task scheduler 216 and an execution monitor 219. Various components in the resource management system 210 may be implemented by hardware, software, firmware or any combinations thereof.

In implementations of the subject matter described herein, the processing unit 122 in the resource pool 110 is supposed to be configured to execute a task of the first service 201. Since the task of the first service 201 does not always occupy the processing unit 122, implementations of the subject matter described herein propose that the processing unit 122 is configured to execute a task of other service, e.g., a task of the second service 202 in a proper period of time, e.g., an idle time period of the processing unit 122, thereby increasing the resource utilization.

In implementations of the subject matter described herein, regarding occupying the processing unit 122, the second service 202 may be considered as having a lower priority than the first service 201. Therefore, when the task of the first service 201 is running on the processing unit 122, it is desired that there is no task of other service contending with the task of the first service 201 on the processing unit 122, so as to avoid the potential interference to the first service 201 and guarantee the quality of service of the first service 201.

The idle time period detector 212 in the resource management system 210 is configured to detect such a time period in the processing unit 122 during which the processing unit 122 can suspend execution of the task of the first service. The execution duration predictor 214 is configured to determine a predicted execution duration of each task of the second service 202. One or more executable tasks 220-1, 220-2, . . . 220-K in the second service 202 may be placed in a task queue 216. For the sake of discussion, these tasks of the second service 202 may be collectively or separately referred to as a task(s) 220.

The task scheduler 218 is configured to select, at least based on the predicted execution duration of the task of the second service 202, one or more tasks 220 that are to be completed within the determined idle period of time, and instruct the execution monitor 219 to schedule the selected task to be executed by the processing unit 122. The execution monitor 219 may comprise a task start module 232 configured to start one or more tasks 220 to be executed and instruct the processing unit 122 to execute the started one or more tasks 220.

In some implementations, the execution monitor 219 may further monitor the execution progress of the one or more tasks 220 on the processing unit 122 so as to avoid the potential interference to the first service 201. In some implementations, the execution monitor 219 may further comprise a related resource manager 234 to manage other types of resources than the processing unit 122 in the resource pool 110, so that the occupancy of other types of resources during the execution of the task of the second service 202 will not generate interference to the first service 201.

In some implementations, the first service 201 and the second service 202 may be different types of services. In some implementations, the first service 201 and the second service 202 have different characteristics at least in terms of occupancy of the processing unit 122.

Specifically, in some implementations, the first service 201 may have randomness and unpredictability when occupying the resource of the processing unit 122, while the second service 202 has predictability when occupying the resource of the processing unit 122. In other words, the first service 201 has a lower predictability than the second service 202 in terms of occupancy of resource of the processing unit 122. The predictability of the resource occupancy of the processing unit by the service may be reflected in the prediction of the execution time of each task of the service. In some implementations, the execution duration of the task of the first service 201 on the processing unit 122 might be unpredictable. For example, the complexity of each task of the first service 201 varies greatly, and the variation pattern of the complexity is random (e.g., depending on user interaction or service design needs), so the execution duration of each task could not be predicted in advance. As shown in FIG. 2, in some examples, the trigger of a specific task of the first service 201 may be based on a user input of the client device 130. Due to the randomness of user interaction, the complexity of the task triggered each time might be different, and further the execution duration on the processing unit 122 differs.

In some implementations, the execution duration of the task of the second service 202 on the processing unit 122 may be predictable. For example, the workload of each task of the second service 202 is relatively stable with slight change, and the execution duration thereof may be determined. Since the task of the second service 202 has a predictable execution duration, it is suitable for execution within the idle period of time of the processing unit 122.

In some implementations, the first service 201 may comprise a service with predetermined requirements on quality of service. Therefore, the processing resource of the processing unit 122 may be monopolized by the task of the first service 201 for a certain period of time, so as to ensure the quality of service. In some implementations, the second service 202 may be selected as a service with certain processing delay tolerance, such as a training service for machine learning models, a testing service, or an offline inference service, etc. Thus, even if the execution duration of the task of the first service 201 is unpredictable, the utilization of the processing unit can be improved by executing the second service 202 during an idle time period of random length while ensuring the requirements on quality of service of the first service 201.

In some implementations, the second service 202 may be selected as a service with finer task granularity. That is, the task of the second service 202 may be divided into finer granularity, and the execution time of each task may be relatively short, so as to facilitate the task scheduling. In some implementations, the second service 202 may be selected as a service with repetitive or iterative tasks. Thus, the resources of the processing unit 122 may be sufficiently utilized within a longer time.

In some implementations, the first service 201 may comprise a streaming media service, and the task of the first service 201 may comprise a frame processing task of the streaming media service, such as a rendering task. In some implementations, the streaming media service may, for example, comprise a gaming service, such as a cloud gaming service. In some implementations, the streaming media service may, for example, comprise services that provide streaming media content, such as a live video service, a video conferencing service, etc. In the streaming media service, the complexity of different frames might differ, and contents of frames to be processed might be random (e.g., based on the user control of game scenes in gaming services), thus exhibiting characteristics of unpredictability and randomness in terms of occupancy of the processing unit. Furthermore, to guarantee the user experience, the streaming media service might provide higher quality of service (QOS) which the client device can support.

In other implementations, in addition to the streaming media service, the first service 201 may further comprise other service with similar characteristics (e.g., the unpredictability and randomness of task execution) in terms of occupancy of the processing unit.

In some implementations, the second service 202 may comprise an operation service of a machine learning model. The machine learning model usually comprises multiple model units (sometimes referred to as processing cores, processing units, etc.), and during running, each model unit processes respective inputs and provides corresponding outputs. In some implementations, the processing of the model unit comprises processing the input based on a specific processing function. A parameter value of the processing function forms a parameter value of the machine learning model. In some implementations, regarding the running service of the machine learning model, a task of the service may comprise the execution of one or more model units.

The execution duration of each model unit of the machine learning model is relatively stable, and varies slightly. In addition, the same machine learning model might run repetitively (e.g., by inputting different data), so its task execution has a characteristic of iterative repetition. With the use of the predictability and iterativeness of the running service of the machine learning model, the predicted execution duration of the model unit in the model may be known in advance.

The machine learning model needs to be run in all the training, test and interference stages. In the training stage, training data is iteratively input to the machine learning model, and a parameter value of the model is updated based on an output of the model, till the training goal is achieved. In the test stage of machine learning, test data is input to the machine learning model to verify whether the model can provide an correct output and further test the model performance. In the inference stage, according to specific application needs, input data to be processed actually is input to the machine learning model so as to determine a corresponding output. In any stage, the machine learning model needs to be run. In some implementations, the second service 202 may comprise a training service and verifying service of the machine learning model. In some implementations, where the user authorization is obtained, the second service 202 may also comprise an inference service of the machine learning model.

In some implementations, the second service 202 may comprise a scientific computing service. The scientific computing service refers to operations that construct scientific equations to solve problems encountered in science and engineering. The scientific computing service can comprise parallel and repetitive operations, and the workload of each scientific computing service is usually predictable. In such implementations, a task of the scientific computing service may comprise the execution of one or more operations. In other implementations, the second service 202 may further comprise other service with similar characteristics (e.g., the predictability, stability and/or low granularity of the task execution) in terms of occupancy of the processing unit.

In some implementations, the processing unit 122 may be any processing unit that is suitable to execute tasks of the first service 201 and the second service 202. In some implementations, the processing unit 122 may comprise a dedicated processing unit, such as GPU, FPGA, ASIC, etc., so as to accelerate the task execution. In some implementations, the processing unit 122 may execute the task under the control of a general-purpose processing unit, e.g., the processing unit 120. The processing unit 120 may, for example, comprise CPU or other central controller. The processing unit 120 may be configured to execute and parse task logic and translate the task logic into commands executable by the processing unit 122.

The resource management system 210 is mainly configured to manage resources in the resource pool 110, especially the usage of resources of the processing unit 122. In some implementations, the resource management system 210 may schedule the task of the second service 202 without changing the computation thereof, so the computation result of the second service will not be affected.

Example implementations of various components in the resource management system 210 will be described in detail below.

### Detection of Idle Period of Time

As described above, the idle time period detector 212 is configured to detect an idle period of time within which the processing unit 122 processes the task of the first service 201. To detect the idle period of time of the processing unit 122, the idle time period detector 212 may be configured to monitor instant execution information of the task of the first service 201 and determine the idle period of time at least based on the monitored instant execution information. Instead of predicting the random behavior of the task execution of the first service in advance (which is often difficult to achieve), by monitoring the task execution of the first service 201 in real time, it is possible to quickly and accurately detect when the processing unit 122 will be idle.

In some implementations, the idle time period detector 212 may detect when a task of the first service 201 is to be completed on the processing unit 122 and when a next task is to start. The period of time between the two tasks may be determined as the idle period of time. The idle time period detector 212 may determine the completion of a certain task of the first service 201 from the instant execution information. In some implementations, the idle time period detector 212 may, based on the requirements on quality of service of the first service 201, further determine when the next task of the first service 201 is to start, i.e., a predicted start time of the next task. Based on the completion time of the previous task and the predicted start time of the next task, the idle period of time of the processing unit 122 may be determined.

In some implementations, the idle time period detector 212 may be configured to obtain a command queue 240 for the first service 201 sent to the processing unit 122. The command queue 240 comprises commands executable by the processing unit 122 which are sent to the processing unit 122 as tasks are triggered. In some implementations, commands in the command queue 240 may be sent to the processing unit 122 through an interface 242. In some implementations, if the first service 201 comprises a streaming media service, and tasks of the first service 201 to be executed on the processing unit 122 comprise a frame processing task, e.g., frame rending, then when such tasks are completed, graphics operations involving frame rendering in the graphics library will be converted into commands executable by the processing unit 122. The interface for transmitting such executable commands may comprise an application programming interface (API).

The idle time period detector 212 may monitor the interface 242 so as to detect from the command queue 240 a start command for start a certain task of the first service 201. The latency caused by the detection of the command queue is very low, usually within one microsecond per frame, so it will not affect the quality of service of the first service 201. If detecting the start command of a task, the idle time period detector 212 may determine that the processing unit 122 is to execute a certain task of the first service 201. To know when the task is to be completed, the idle time period detector 212 may insert into the command queue 240 a notification command for notifying the completion of the task. In some implementations, the notification command may be inserted into the end of the command queue 240 for the current task. The idle time period detector 212 may be configured to detect a start command of a task and insert a notification command of task completion for different types of interfaces and command generation methods.

Upon completion of task execution, an execution result of the task may be passed to a next destination via the interface 242 and finally transmitted to the client device 130. Since the notification command is inserted into the command queue 240, the idle time period detector 212 may receive a notification of task completion, so that the completion time of the current task may be determined.

In some implementations, the idle time period detector 212 may determine a predicted start time of a subsequent task of the first service 201 based on the quality of service (QOS) requirements of the first service 201. The QOS requirements will affect the frequency of task triggering of the first service 201.

In some implementations, if the first service 201 comprises a streaming media service, then the QoS requirement may comprise a frame rate (FPS) requirement, e.g., indicating the maximum frame rate for the streaming media service. If a task of the streaming media service is a frame processing task, then FPS will determine the time interval between two frame processing tasks. For example, if the FPS requirement is 60 FPS, this means that a frame occurs approximately every 16.67 ms, so the occurrence interval of frame processing tasks is 16.67 ms. Since the idle time period detector 212 may be notified of the completion time of frame processing, it can be determined based on the occurrence interval of tasks when the next frame processing task is to start. The processing unit 122 may be determined to be in an idle state during the period of time between the completion of the previous frame processing and the start of the next frame processing.

In some implementations, the idle time period detector 212 may be configured to determine QoS requirements of the first service 201. For example, the QoS requirements may be determined by monitoring the trigger interval (e.g., the rendering interval of multiple frames) of multiple tasks of the first service 201 when the first service 201 is started. The overhead and error of this approach is almost negligible.

Detecting the idle period of time of the processing unit 122 by monitoring the instant execution information and the QoS requirements makes it possible for the idle time period detector 212 to support a wide range of detection for different first services 201 without the need to specifically modify the detection approach for each service. In other implementations, the idle time period detector 212 may further obtain other instant execution information so as to determine in real time the idle period of time between consecutive tasks of the first service 201. The implementation of the subject matter described herein is not limited in this regard.

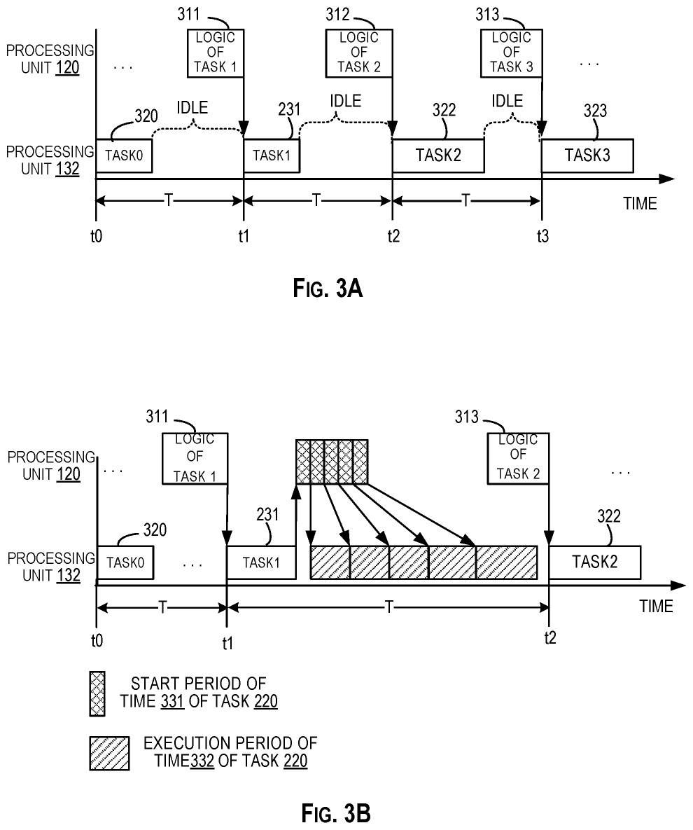

FIG. 3A illustrates an example of occupancy of resource of the processing unit 122 when separately running a task of the first service 201. As shown in FIG. 3A, the processing unit 122 executes task 0, task 1, task 2 and task 3 in periods of time 320, 331, 322, 323 respectively. The task execution by the processing unit 122 may be controlled by commands issued by the processing unit 120. For example, the processing unit 120 runs the logic of task 1 in a period of time 311 and sends a corresponding execution command to the processing unit 122 to cause the processing unit 122 to execute specific computation operation. Similarly, the processing unit 120 runs the logic of task 2 and task 3 in periods of time 312 and 313 respectively and after the completion of running, send corresponding execution commands to the processing unit 122.

The trigger interval (denoted as “T”) of different tasks of the first service 201 may be based on the QoS requirements of the first service 201, e.g., the FPS requirement for the streaming media service. As seen from FIG. 3A, since the processing unit 122 execute tasks at a faster speed, the processing unit 122 will be in an idle state during the time after the completion of the previous task and before the arrival of the next task. In the implementation of the subject matter described herein, it is desirable to schedule tasks of other service to be executed within the idle period of time of the processing unit 122, so as to improve the resource utilization of the processing unit 122 without generating interference to the first service 201.

### Prediction of Task Execution Duration and Scheduling of Tasks

After detecting the idle period of time of the processing unit 122, the task scheduler 218 may select one or more tasks 220 of the second service 202 to be scheduled to the processing unit 122 for execution, so as to make full use of the processing resources. In order to avoid contending with the first service 201 for the processing unit 122, during task scheduling, the task scheduler 218 may select the one or more tasks 220 that can be completed within the determined idle period of time. The task scheduler 218 may obtain the predicted execution duration of each task 220 of the second service 202 from the execution duration predictor 214, and based on the predicted execution duration of a task, determine which tasks 220 can be executed before the next task of the first service 201 starts. That is, the total predicted execution duration of the one or more tasks 220 to be scheduled does not exceed the determined idle period of time.

In some implementations, as discussed above, the second service 202 may be selected as a service whose task execution duration is predictable and less variable. In some implementations, the second service 202 may divide a task into finer granularity, so that each task has a shorter execution duration and is easy to be scheduled to the idle period of time of the processing unit 122 for execution. For example, the second service 202 may comprise an operation service of a machine learning model, where the execution duration of each model unit is predictable and less variable. In addition, a survey illustrates that many types of model units have an execution time less than 1 ms, so they are suitable to be scheduled to the idle period of time of the processing unit for execution.

In some implementations, the execution duration predictor 214 may determine the predicted execution duration of each task 220 of the second service 202 by executing in advance the second service 202 at least once, e.g., running the machine learning model at least once. The second service 202 may be executed by a further processing unit, which may be of the same type as the processing unit 122 (e.g., both are GPUs) and which is not configured to execute the first service 201. Due to the stability of tasks of the second service 202, the predicted execution duration of each task 220 can be determined relatively accurately. The execution duration predictor 214 may record the determined predicted execution duration.

In some implementations, the execution duration predictor 214 may further determine the predicted execution duration of the task 220 of the second service 202 in other way. For example, where model data can be obtained or is allowed to be obtained, the execution duration predictor 214 may additionally or alternatively analyze the structure of the machine learning model, the type of the model unit, the type of the input data, etc., to determine the predicted execution duration of the task 220. Regarding a further second service, the execution duration predictor 214 may also determine a predicted execution duration of a task in an appropriate way. The implementation of the subject matter described herein is not limited in this regard.

In some implementations, the task 220 in the task queue 216 may be placed in order that, for example, depends on the processing logic of the second service 202. When scheduling a task, the task scheduler 218 may schedule the task 220 from the task queue 216 in order. If the predicted execution duration of the task 220 at the head of the task queue 216 is less than the idle period of time of the processing unit 122, the task scheduler 218 may instruct the task executor 219 to send the task to the processing unit 122 for execution. The execution duration predictor 214 may determine whether the next task 220 can be completed within the rest of the idle period of time of the processing unit 122 or not. If yes, the execution duration predictor 214 may continue to instruct the task executor 219 to send the task to the processing unit 122 for execution.

In some implementations, before the task 220 is executed by the processing unit 122, the initialization operation for the task 220 needs to be completed so as to create a context for task execution, whereas the overhead of the initialization does not affect the scheduling of the task 220. In some implementations, the task start module 232 may be configured to perform a necessary task start operation, e.g., configuring a parameter value, input data and the like of the model unit. The overhead for the task start operation is typically less than or equal to the execution time of the task 220. For example, regarding the operation service of the machine learning model, the start overhead for the model unit might be around 10 us, which usually does not exceed the actual execution time of the model unit.

In some implementations, such initialization and start operations may be performed by a general-purpose processing unit, e.g., the processing unit 120. The processing unit 120 may operate asynchronously with the processing unit 122 to improve the processing efficiency. FIG. 3B illustrates an example of occupancy of resource for co-deployment of multiple services on a processing unit. The figure illustrates that the task 220 of the second service 202 is scheduled to the processing unit 122 for execution within the idle period of time between the completion of task 1 and the start of task 2. The processing unit 120 may be configured to perform a start operation for the task 220 and after completion of the start, instruct the processing unit 122 to start executing the task 220. The start operation and execution operation for the task 220 may be performed asynchronously by the processing unit 120 and the processing unit 122. Thus, the processing unit 122 needs to be idle waiting for the start period of time 331 of the first scheduled task 220. Since the start operation costs very little time, the waiting period of time is negligible. Afterwards, the processing unit 122 may execute the started task 220 in the period of time 332, and the execution periods of time 332 for the multiple tasks 220 (if scheduled) may be consecutive.

### Monitoring of Execution

In some implementations, where one or more tasks 220 of the second service 202 are scheduled to the processing unit 122 for execution, the task executor 219 further monitors the execution of tasks. In some cases, the actual execution duration of some task or tasks 220 might exceed the predicted execution duration, so that the task 220 cannot be completed before the next task of the first service 201 is triggered. The reason why the actual execution time of the task exceeds the predicted execution time might be execution errors, data errors, etc. If the execution of such a task cannot end in time, then the execution of a task of the first service 201 might be delayed.

To avoid causing interference to the first service 201 and degrading the QoS of the first service 201, in some implementations, on detecting that one or more tasks 220 of the second service 202 fail to be completed before the previously determined idle period of time expires, the task executor 220 may terminate the execution process of the task 220 on the processing unit 122, so that the processing unit 122 may be quickly reclaimed for executing the task of the first service 201.

In some implementations, on detecting that the one or more tasks 220 fail to be completed before the idle period of time of the processing unit 122 expires, the task executor 219 may immediately instruct the processing unit 122 to stop executing these tasks. Such an approach may be referred to as a hard guarantee for the QoS of the first service 201.

In some implementations, on detecting that the one or more tasks 220 fail to be completed before the idle period of time of the processing unit 122 expires, the task executor 219 does not temporarily terminate execution of the task 220 but monitors a drop range of the QoS of the first service 201 while maintaining the execution of the task. If the QoS of the first service 201 does not drop below a QoS threshold, the processing unit 122 may have the chance to continue executing the currently uncompleted task 220, and may complete another one or more tasks 220 before the QoS drops below the threshold. If the QoS of the first service 201 drops below the QoS threshold, this means that further drop will affect the service experience of the first service 201, and the task executor 219 may terminate the task that is not yet completed on the processing unit 122. For example, the QOS requirement of the first service 201 indicates the FPS requirement, delaying the processing time of the next frame will cause a drop in FPS. If the FPS drop range is within a certain threshold, the processing unit 122 may be caused to continue executing the tasks of the second service 202 until the FPS drops below the threshold.

The approach of allowing a certain degree of QoS drop can be referred to as a soft guarantee for the QoS of the first service 201. This approach is especially suitable for second services with some tasks having long predicted time of execution. For these second services, the “soft guarantee” approach can further improve the utilization of the processing unit 122 than the “hard guarantee” approach. In addition, the “hard guarantee” approach is applicable to scenarios in which a slight drop in QoS of the first service does not affect the service experience.

In some implementations, to terminate the uncompleted task 220 on the processing unit 12 as soon as possible, an asserting signal for the task 220 may be sent at a higher priority to quickly terminate the task and occupy the processing unit 122 for task execution of the first service 202. The termination of the task 220 will cause all related data in the memory to be cleared, which might result in loss of execution progress of the second service 202.

For example, if some tasks 220 of the second service 202 are interrupted, it might be necessary to re-run the entire second service 202, especially in the training service of machine learning models. For the training service of the machine learning model, after using a batch of training data to iteratively run the model for many times, parameter values of the model are updated through all the running results. If a task of some model unit or units is terminated during certain running, then the execution progress of the model in this round might be lost. Although the second service 202 might periodically save checkpoints of parameter values, the save frequency of checkpoints is relatively low (usually every a few training epochs that might take hours).

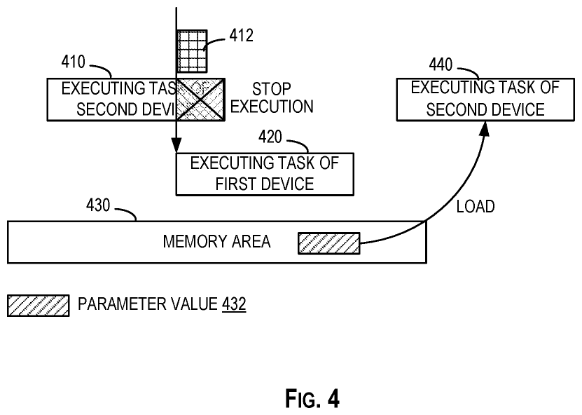

When terminating the uncompleted task 220, it is desirable to reduce the damage to the execution progress of the second service 202. In some implementations, a memory area may be set to store parameter values for configuring tasks of the second service, e.g., storing parameter values of the machine learning model. Parameter values in the memory area may be updated as execution of the task of the second service 202 is completed. If tasks of the second service 202 are executed in iterations, e.g., when executing the training service of the machine learning model, parameter values in the memory area may be updated every time the machine learning model runs once. FIG. 4 illustrates an example of such a memory area. As shown, suppose a certain task 220 of the second service 202 that has a relatively long actual execution duration 410 is not completed when a task of the first service 202 is triggered. Then the task 220 may be caused to be terminated through an asserting signal 412, and the processing unit 122 is made to start executing a task of the first service 201 within a period of time 420. A memory area 430 may be set to store a parameter value 432 required by a task of the second service 202.

When a new idle period of time 440 of the processing unit 122 is detected next time in a similar way as discussed above, execution of the task 220 of the second service 202 may resume. At this point, a task to be executed may be configured based on a parameter value stored in the memory area 430, so that the impact on the service progress of the second service 202 may be minimized. Note that terminating the task of the second service 202 on the processing unit 122 is usually to avoid the interference to the first service 201, so parameter values stored in the memory area may be maintained. In some implementations, to maintain a parameter combination while keeping the second service 202 suspended, a separate process from the second service 202 may be utilized to construct a memory area to store parameter values. When resuming execution of the task of the second service 202, a pointer of the memory area may be directly provided to a memory management process of the task 220 to be executed. In some implementations, if the processing unit 122 supports inter-process communication (IPC), a memory area for storing parameter values may be created from the memory of the processing unit 122. Thus, when the task 220 of the second service 202 is enabled, no memory copy operation is needed. In some implementations, the parameter area for storing parameter values may also be located on other memory, e.g., on a host memory, and may be copied from other memory to the memory of the processing unit 122 during execution of a task.

In some implementations above, discussion has been presented to scheduling one task of the second service 202 to be executed on the processing unit 122 within the idle period of time so as to improve the resource utilization. In other implementations, where needed, multiple tasks of the second service 202 with predicted execution duration may be scheduled to be executed on the processing unit 122 within the idle period of time in a similar way.

### Management of Other Resource Contention

Besides the processing resource of the processing unit 122, execution of the tasks of the first service 201 and the second service 202 might further involve other resources in the resource pool 110, e.g., the processing resource of the processing unit 120, the memory resource 114, the interface resource 116, the storage device resource 118, etc. If the same resource is utilized to support the first service 201 and the second service 202, then the resource needs management for interference avoidance. In some implementations, the related resource manager 234 in the task executor 219 in FIG. 2 may be configured to manage other resources. In some implementations, the processing unit 120, e.g., CPU, may be configured to perform pre-processing on various tasks of the first service 201 and the second service 202. For example, regarding the streaming media service, the processing unit 120 may be used to perform service initialization, obtain and analyze user interaction, process streaming media logic, simulate service effects, etc. For the operation service of the machine learning model, the processing unit 120 may be used for data pre-processing, e.g., image data decoding, image re-shaping, data augmentation, etc. If the second service 202 the processing resource 120 heavily, resource contention may appear, resulting in a decrease in QoS of the first service 201, e.g., a decrease in FPS of the streaming media service, an increase of loading time, etc.

In some implementations, the resource contention on the processing unit 120 may be avoided by setting the priority of processes. For example, in the processing unit 120, a first thread may be utilized to perform pre-processing of a task of the first service 201, and a second thread may be utilized to perform pre-processing of a task of the second service 202. The priority of the first thread may be set higher than that of the second thread. Compared with not setting the priority or setting the same priority, setting the thread of the first service 201 to have a higher priority than the thread of the second service 202 may mitigate the interference on the processing unit 120.

In some implementations, the processing unit 122 interfaces with the memory to cache required data on the memory during execution of the task. To interface the processing unit 122 with the memory needs to utilize the interface resource 116, e.g., a PCIe interface and other high-speed interface. For example, task execution for the streaming media service needs to obtain primitive data on the memory through an interface and cache rendered frames, etc. An operation service of the machine learning model needs to be transfer data and model parameter values through an interface. Resource contention might occur on the interface between the processing unit 122 and the memory. As the processing unit 122 is shared with the second service 202, the data transfer rate achieved by the first service 201 on the interface might decrease.

To avoid contention for the interface resource, in some implementations, the bandwidth reservation technique may be utilized to reserve enough interface bandwidth for the first service 201, e.g., reserve a predetermined size of interface bandwidth of the interface for the first service 201. The interface may be allowed to transfer data of the second service 202 when the first service 201 is not using the interface. Various appropriate techniques may be utilized to realize the bandwidth reservation for the interface, and the implementation of the subject matter described herein is not limited in this regard.

In some implementations, for the storage device resource 118, both task execution of the first service 201 and the second service 202 might need to load data from a storage device, e.g., the streaming media service needs to read rendering resources (e.g., texture) from the storage device, and the operation task of the machine learning model needs to read data required by processing from the storage device. Contention on storage device input/output I/O might lead to longer data loading time for the first service 201, affect the quality of service and even degrade the processing performance. For example, if I/O contention is severe, content missing in some frames of the streaming media might be observed. Therefore, in some implementations, I/O isolation techniques may be utilized to isolate data I/O operations related to the first service 201 from I/O operations of the second service 202. I/O isolation techniques may, for example, include namespace setting, I/O priority setting, etc., so that the I/O operations of the first service 201 are isolated from those of the second service 202, and interference is avoided.

In some implementations, since the task of the second service 202 is always scheduled to be executed within the idle period of time of the processing unit 122, for the memory and cache of the processing unit 122, the data transfer of the second service 202 usually does not overlap with the data transfer of the first service 201, and thus no interference will be generated. During executing the task of a certain service, the cache data generated by the task of a previous service will be flushed, and the cache will not be occupied. In addition, since commands for the processing unit 122 are usually issued in order without preemption, there is no context switching overhead of the processing unit 122.

In some implementations, if the task execution of the first service 201 and the second service 202 needs network resources, e.g., transferring to-be-processed data/instructions or transferring an execution result, data communication of different services may be completed in separate networks, and thus there is no interference in network. In some implementations, for the streaming media service, after frame rendering is completed, a frame encoder might be needed to encode the rendered frame to transmit the encoded stream over the network. The second service 202 is usually not selected as a similar streaming media service, and thus there is no contention on the frame encoder.

### Example Process

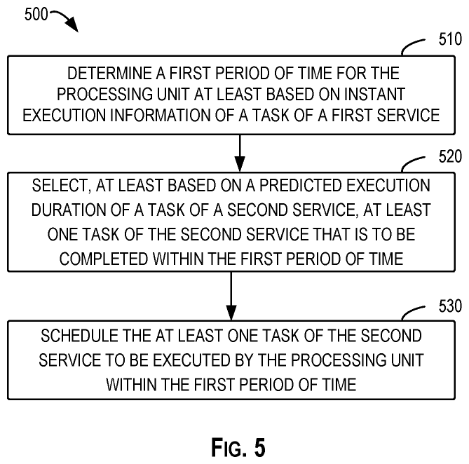

FIG. 5 illustrates a flowchart of a process 500 for resource management according to some implementations of the subject matter described herein. The procedure 500 may be implemented at the resource management system 210 in FIG. 2.

At block 510, the resource management system 210 determines a first period of time for the processing unit at least based on instant execution information of a task of a first service. The first period of time is such a period of time during which execution of the task of the first service is suspended on the processing unit.

At block 520, the resource management system 210 selects, at least based on a predicted execution duration of a task of a second service, at least one task of the second service that is to be completed within the first period of time.

At block 530, the resource management system 210 schedules the at least one task of the second service to be executed by the processing unit within the first period of time.

In some implementations, the first service and the second service have different characteristics in terms of occupancy of the processing unit.

In some implementations, predictability of the first service is lower than predictability of the second service in terms of occupancy of resource of the processing unit.

In some implementations, determining the first period of time comprises: determining a completion time of a first task of the first service based on the instant execution information; determining a predicted start time of a second task of the first service based on a requirement on quality of service for the first service, the second task to be executed following the first task; and determining the first period of time based on the completion time and the predicted start time.

In some implementations, the instant execution information comprises a command queue to be sent to the processing unit for the first service. In some implementations, determining the completion time of the first task comprises: detecting, from the command queue, a start command for the first task; in response to detection of the start command, inserting, into the command queue, a notification command for notifying completion of the first task; and in response to receiving a notification of completion of the first task, determining the completion time of the first task.

In some implementations, the first service comprises a streaming media service, a task of the first service comprises a processing task for a frame of the streaming media service, and the requirement on quality of service comprises a frame rate requirement for the streaming media service.

In some implementations, the second service comprises an operation service of a machine learning model or a scientific computing service.

In some implementations, the method further comprises: determining the predicted execution duration of a task of the second service by executing the task of the second service on a further processing unit for at least once, the further processing unit being of the same type as the processing unit.

In some implementations, the method further comprises: during execution of the at least one task of the second service, if it is detected that one or more tasks of the at least one task of the second service fail to be completed before the first period of time expires, terminating execution of the one or more tasks on the processing unit.

In some implementations, terminating the execution of the one or more tasks comprises: if it is detected that the one or more tasks fail to be completed before the first period of time expires, monitoring whether a quality of service of the first service drops below a threshold quality of service while maintaining the execution of the one or more tasks; and in accordance with a determination that the quality of service of the first service drops below the threshold quality of service, terminating execution of an uncompleted task of the one or more tasks.

In some implementations, the method further comprises: storing, in a memory area, a parameter value for configuring a task of the second service, the parameter value to be updated as execution of the task of the second service is completed.

In some implementations, the method further comprises: determining, at least based on further instant execution information of a task of the first service, a second period of time for the processing unit during which execution of the task of the first service is suspended on the processing unit; selecting, at least based on the predicted execution duration of the task of the second service, at least one further task of the second service that is to be completed within the second period of time; and scheduling the at least one further task of the second service to be executed by the processing unit within the second period of time.

In some implementations, the method further comprises performing at least one of the following: performing a pre-processing operation of a task of the first service with a first thread and a pre-processing operation of a task of the second service with a second thread, a priority of the first thread being higher than a priority of the second threshold; for an interface between the processing unit and a memory, reserving a predetermined size of interface bandwidth of the interface for the first service, or isolating a data input/output operation related to the first service from a data input/output operation related to the second service.

### Example Device

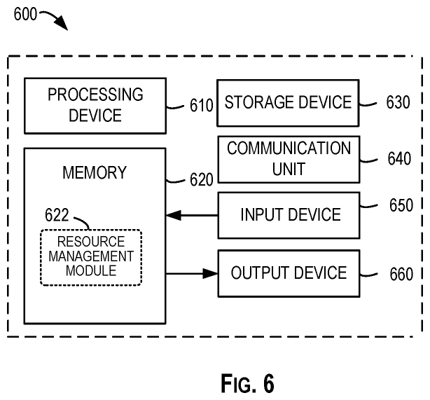

FIG. 6 illustrates a schematic block diagram of an electronic device in which various implementations of the subject matter described herein can be implemented. It would be appreciated that the electronic device 600 as shown in FIG. 6 is merely provided as an example, without suggesting any limitation to the functionalities and scope of implementations of the subject matter described herein.

As shown in FIG. 6, the electronic device 600 is in form of a general-purpose computing device. Components of the electronic device 600 may include, but are not limited to, one or more processors or processing devices 610, a memory 620, a storage device 630, one or more communication units 640, one or more input devices 650, and one or more output devices 660. In some implementations, the electronic device 600 may be implemented as a device with computing capability, such as a computing device, a computing system, a server, a mainframe and so on.

The processing device 610 can be a physical or virtual processor and can execute various processing based on the programs stored in the memory 620. In a multi-processor system, a plurality of processing units execute computer-executable instructions in parallel so as to enhance parallel processing capability of the electronic device 600. The processing device 610 may include a central processing unit (CPU), a graphics processing unit (GPU), a microprocessor, a controller, and/or a microcontroller.

The electronic device 600 usually includes various computer storage media. Such media may be any available media accessible by the electronic device 600, including but not limited to, volatile and non-volatile media, or detachable and non-detachable media. The memory 620 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 630 may be any detachable or non-detachable medium and may include computer-readable medium such as a memory, a flash memory drive, a magnetic disk or any other media that can be used for storing information and/or data and are accessible by the electronic device 600.

The electronic device 600 may further include additional detachable/non-detachable, volatile/non-volatile memory media. Although not shown in FIG. 6, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 640 implements communication with another computing device via the communication medium. In addition, the functionalities of components in the electronic device 600 may be implemented by a single computing cluster or a plurality of computing machines that can communicate with each other via communication connections. Thus, the electronic device 600 may operate in a networked environment using a logic connection with one or more other servers, network personal computers (PCs), or further general network nodes.

The input device 650 may include one or more of a variety of input devices, such as a mouse, keyboard, data import device and the like. The output device 660 may be one or more output devices, such as a display, data export device and the like. By means of the communication unit 640, the electronic device 600 may further communicate with one or more external devices (not shown) such as storage devices and display devices, one or more devices that enable the user to interact with the electronic device 600, or any devices (such as a network card, a modem and the like) that enable the electronic device 600 to communicate with one or more other computing devices, if required. Such communication may be performed via input/output (I/O) interfaces (not shown).

In some implementations, as an alternative of being integrated on a single device, some or all components of the electronic device 600 may also be arranged in the form of cloud computing architecture. In the cloud computing architecture, the components may be provided remotely and work together to implement the functionalities described in the subject matter described herein. In some implementations, cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The electronic device 600 may be used to implement resource management in accordance with various implementations of the subject matter described herein. The memory 620 may include one or more modules having one or more program instructions. These modules may be accessed and run by the processing unit 610 to perform functions of various implementations described herein. For example, the memory 620 may include a resource management module 622 for performing management of resources for a specific processing unit. As shown in FIG. 6, the electronic device 600 may obtain an input required for resource management through the input device 650 and provide an output of resource management through the output device 660. In some implementations, the electronic device 600 may further receive an input from other device (not shown) via the communication unit 640.

### EXAMPLE IMPLEMENTATIONS

Some example implementations of the subject matter described herein are listed below.

In an aspect, the subject matter described herein provides a computer-implemented method. The method comprises: determining, at least based on instant execution information of a task of a first service, a first period of time for the processing unit during which execution of the task of the first service is suspended on the processing unit; selecting, at least based on a predicted execution duration of a task of a second service, at least one task of the second service that is to be completed within the first period of time; and scheduling the at least one task of the second service to be executed by the processing unit within the first period of time.

In some example implementations, the first service and the second service have different characteristics in terms of occupancy of the processing unit.

In some example implementations, predictability of the first service is lower than predictability of the second service in terms of occupancy of resource of the processing unit.

In some example implementations, determining the first period of time comprises: determining a completion time of a first task of the first service based on the instant execution information; determining a predicted start time of a second task of the first service based on a requirement on quality of service for the first service, the second task to be executed following the first task; and determining the first period of time based on the completion time and the predicted start time.

In some example implementations, the instant execution information comprises a command queue to be sent to the processing unit for the first service. In some example implementations, determining the completion time of the first task comprises: detecting, from the command queue, a start command for the first task; in response to detection of the start command, inserting, into the command queue, a notification command for notifying completion of the first task; and in response to receiving a notification of completion of the first task, determining the completion time of the first task.

In some example implementations, the first service comprises a streaming media service, a task of the first service comprises a processing task for a frame of the streaming media service, and the requirement on quality of service comprises a frame rate requirement for the streaming media service.

In some example implementations, the second service comprises an operation service of a machine learning model or a scientific computing service.

In some example implementations, the method further comprises: determining the predicted execution duration of a task of the second service by executing the task of the second service on a further processing unit for at least once, the further processing unit being of the same type as the processing unit.

In some example implementations, the method further comprises: during execution of the at least one task of the second service, if it is detected that one or more tasks of the at least one task of the second service fail to be completed before the first period of time expires, terminating execution of the one or more tasks on the processing unit.

In some example implementations, terminating the execution of the one or more tasks comprises: if it is detected that the one or more tasks fail to be completed before the first period of time expires, monitoring whether a quality of service of the first service drops below a threshold quality of service while maintaining the execution of the one or more tasks; and in accordance with a determination that the quality of service of the first service drops below the threshold quality of service, terminating execution of an uncompleted task of the one or more tasks.

In some example implementations, the method further comprises: storing, in a memory area, a parameter value for configuring a task of the second service, the parameter value to be updated as execution of the task of the second service is completed.

In some example implementations, the method further comprises: determining, at least based on further instant execution information of a task of the first service, a second period of time for the processing unit during which execution of the task of the first service is suspended on the processing unit; selecting, at least based on the predicted execution duration of the task of the second service, at least one further task of the second service that is to be completed within the second period of time; and scheduling the at least one further task of the second service to be executed by the processing unit within the second period of time.

In some example implementations, the method further comprises performing at least one of the following: performing a pre-processing operation of a task of the first service with a first thread and a pre-processing operation of a task of the second service with a second thread, a priority of the first thread being higher than a priority of the second threshold; for an interface between the processing unit and a memory, reserving a predetermined size of interface bandwidth of the interface for the first service, or isolating a data input/output operation related to the first service from a data input/output operation related to the second service.

In another aspect, the subject matter described herein provides an electronic device. The electronic device comprises: a processor; and a memory coupled to the processor and having instructions stored thereon, the instructions, when executed by the processor, causing the device to perform acts comprising: determining, at least based on instant execution information of a task of a first service, a first period of time for the processing unit during which execution of the task of the first service is suspended on the processing unit; selecting, at least based on a predicted execution duration of a task of a second service, at least one task of the second service that is to be completed within the first period of time; and scheduling the at least one task of the second service to be executed by the processing unit within the first period of time.

In some example implementations, the first service and the second service have different characteristics in terms of occupancy of the processing unit.

In some example implementations, predictability of the first service is lower than predictability of the second service in terms of occupancy of resource of the processing unit.

In some example implementations, determining the first period of time comprises: determining a completion time of a first task of the first service based on the instant execution information; determining a predicted start time of a second task of the first service based on a requirement on quality of service for the first service, the second task to be executed following the first task; and determining the first period of time based on the completion time and the predicted start time.

In some example implementations, the instant execution information comprises a command queue to be sent to the processing unit for the first service. In some example implementations, determining the completion time of the first task comprises: detecting, from the command queue, a start command for the first task; in response to detection of the start command, inserting, into the command queue, a notification command for notifying completion of the first task; and in response to receiving a notification of completion of the first task, determining the completion time of the first task.

In some example implementations, the first service comprises a streaming media service, a task of the first service comprises a processing task for a frame of the streaming media service, and the requirement on quality of service comprises a frame rate requirement for the streaming media service.

In some example implementations, the second service comprises an operation service of a machine learning model or a scientific computing service.

In some example implementations, the acts further comprise: determining the predicted execution duration of a task of the second service by executing the task of the second service on a further processing unit for at least once, the further processing unit being of the same type as the processing unit.

In some example implementations, the acts further comprise: during execution of the at least one task of the second service, if it is detected that one or more tasks of the at least one task of the second service fail to be completed before the first period of time expires, terminating execution of the one or more tasks on the processing unit.

In some example implementations, terminating the execution of the one or more tasks comprises: if it is detected that the one or more tasks fail to be completed before the first period of time expires, monitoring whether a quality of service of the first service drops below a threshold quality of service while maintaining the execution of the one or more tasks; and in accordance with a determination that the quality of service of the first service drops below the threshold quality of service, terminating execution of an uncompleted task of the one or more tasks.

In some example implementations, the acts further comprise: storing, in a memory area, a parameter value for configuring a task of the second service, the parameter value to be updated as execution of the task of the second service is completed.

In some example implementations, the acts further comprise: determining, at least based on further instant execution information of a task of the first service, a second period of time for the processing unit during which execution of the task of the first service is suspended on the processing unit; selecting, at least based on the predicted execution duration of the task of the second service, at least one further task of the second service that is to be completed within the second period of time; and scheduling the at least one further task of the second service to be executed by the processing unit within the second period of time.

In some example implementations, the acts further comprise performing at least one of the following: performing a pre-processing operation of a task of the first service with a first thread and a pre-processing operation of a task of the second service with a second thread, a priority of the first thread being higher than a priority of the second threshold; for an interface between the processing unit and a memory, reserving a predetermined size of interface bandwidth of the interface for the first service, or isolating a data input/output operation related to the first service from a data input/output operation related to the second service.

In a yet further aspect, the subject matter described herein provides a computer program product being tangibly stored in a computer storage medium and comprising computer-executable instructions, the computer-executable instructions, when executed by a device, causing the device to perform acts comprising: determining, at least based on instant execution information of a task of a first service, a first period of time for the processing unit during which execution of the task of the first service is suspended on the processing unit; selecting, at least based on a predicted execution duration of a task of a second service, at least one task of the second service that is to be completed within the first period of time; and scheduling the at least one task of the second service to be executed by the processing unit within the first period of time.

In some example implementations, the first service and the second service have different characteristics in terms of occupancy of the processing unit.

In some example implementations, predictability of the first service is lower than predictability of the second service in terms of occupancy of resource of the processing unit.

In some example implementations, determining the first period of time comprises: determining a completion time of a first task of the first service based on the instant execution information; determining a predicted start time of a second task of the first service based on a requirement on quality of service for the first service, the second task to be executed following the first task; and determining the first period of time based on the completion time and the predicted start time.

In some example implementations, the instant execution information comprises a command queue to be sent to the processing unit for the first service. In some example implementations, determining the completion time of the first task comprises: detecting, from the command queue, a start command for the first task; in response to detection of the start command, inserting, into the command queue, a notification command for notifying completion of the first task; and in response to receiving a notification of completion of the first task, determining the completion time of the first task.

In some example implementations, the first service comprises a streaming media service, a task of the first service comprises a processing task for a frame of the streaming media service, and the requirement on quality of service comprises a frame rate requirement for the streaming media service.

In some example implementations, the second service comprises an operation service of a machine learning model or a scientific computing service.

In some example implementations, the acts further comprise: determining the predicted execution duration of a task of the second service by executing the task of the second service on a further processing unit for at least once, the further processing unit being of the same type as the processing unit.

In some example implementations, the acts further comprise: during execution of the at least one task of the second service, if it is detected that one or more tasks of the at least one task of the second service fail to be completed before the first period of time expires, terminating execution of the one or more tasks on the processing unit.

In some example implementations, terminating the execution of the one or more tasks comprises: if it is detected that the one or more tasks fail to be completed before the first period of time expires, monitoring whether a quality of service of the first service drops below a threshold quality of service while maintaining the execution of the one or more tasks; and in accordance with a determination that the quality of service of the first service drops below the threshold quality of service, terminating execution of an uncompleted task of the one or more tasks.

In some example implementations, the acts further comprise: storing, in a memory area, a parameter value for configuring a task of the second service, the parameter value to be updated as execution of the task of the second service is completed.

In some example implementations, the acts further comprise: determining, at least based on further instant execution information of a task of the first service, a second period of time for the processing unit during which execution of the task of the first service is suspended on the processing unit; selecting, at least based on the predicted execution duration of the task of the second service, at least one further task of the second service that is to be completed within the second period of time; and scheduling the at least one further task of the second service to be executed by the processing unit within the second period of time.

In some example implementations, the acts further comprise performing at least one of the following: performing a pre-processing operation of a task of the first service with a first thread and a pre-processing operation of a task of the second service with a second thread, a priority of the first thread being higher than a priority of the second threshold; for an interface between the processing unit and a memory, reserving a predetermined size of interface bandwidth of the interface for the first service, or isolating a data input/output operation related to the first service from a data input/output operation related to the second service.

In a yet further aspect, the subject matter described herein provides a computer readable medium having computer-executable instructions stored thereon, the computer-executable instructions, when executed by a device, causing the device to perform one or more example implementations of the method in the above aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination. Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method comprising:
determining, at least based on instant execution information of a task of a first service, a first period of time for the processing unit during which the processing unit suspends execution of tasks of the first service;
selecting, at least based on predicted execution durations of tasks of a second service, at least one task of the second service that can be completed within the first period of time; and
scheduling the at least one task of the second service to be executed by the processing unit within the first period of time.

2. The method of claim 1, wherein predictability of resource occupancy of the processing unit for the first service is lower than the second service.

3. The method of claim 1, wherein determining the first period of time comprises:
determining a completion time of a first task of the first service based on the instant execution information;
determining a predicted start time of a second task of the first service based on a requirement on quality of service for the first service, the second task to be executed following the first task; and
determining the first period of time based on the completion time and the predicted start time.

4. The method of claim 3, wherein the instant execution information comprises a command queue to be sent to the processing unit for the first service, and wherein determining the completion time of the first task comprises:
detecting, from the command queue, a start command for the first task;
in response to detecting the start command, inserting into the command queue a notification command for notifying a completion of the first task; and
in response to receiving a notification of completion of the first task, determining the completion time of the first task.

5. The method of claim 3, wherein the first service comprises a streaming media service, tasks of the first service comprise processing tasks for a frame of the streaming media service; and wherein the requirement on quality of service comprises a frame rate requirement for the streaming media service.

6. The method of claim 1, wherein the second service comprises an operation service of a machine learning model or a scientific computing service.

7. The method of claim 1, further comprising:
determining the predicted execution durations of tasks of the second service by executing the tasks of the second service on a further processing unit at least once, the further processing unit being of the same type as the processing unit.

8. The method of claim 1, further comprising:
during execution of the at least one task of the second service, in response to detecting that one or more of the at least one task of the second service fail to be completed before the first period of time expires, terminating execution of the one or more tasks on the processing unit.

9. The method of claim 8, wherein terminating the execution of the one or more tasks comprises:
in response to detecting that the one or more tasks fail to be completed before the first period of time expires, monitoring whether a quality of service of the first service drops below a threshold quality of service while maintaining the execution of the one or more tasks; and
in accordance with a determination that the quality of service of the first service drops below the threshold quality of service, terminating execution of an uncompleted task of the one or more tasks.

10. The method of claim 8, further comprising:
storing, in a memory area, a parameter value for configuring a task of the second service, the parameter value to be updated as execution of the task of the second service is completed.

11. The method of claim 10, further comprising:
determining, at least based on further instant execution information of tasks of the first service, a second period of time for the processing unit during which the processing unit suspends execution of the tasks of the first service;
selecting, at least based on the predicted execution duration of the task of the second service, at least one further task of the second service that can be completed within the second period of time; and
scheduling the at least one further task of the second service to be executed by the processing unit within the second period of time.

12. The method of claim 1, further comprising performing at least one of the following:
performing a pre-processing operation of tasks of the first service with a first thread and a pre-processing operation of tasks of the second service with a second thread, a priority of the first thread being higher than a priority of the second threshold,
for an interface between the processing unit and a memory, reserving a predetermined size of interface bandwidth of the interface for the first service, or
isolating a data input/output operation related to the first service from a data input/output operation related to the second service.

13. An electronic device comprising:
a processor; and
a memory coupled to the processor and having instructions stored thereon, the instructions, when executed by the processor, causing the device to perform acts comprising:
determining, at least based on instant execution information of a task of a first service, a first period of time for the processing unit during which the processing unit suspends execution of tasks of the first service;
selecting, at least based on predicted execution durations of tasks of a second service, at least one task of the second service that can be completed within the first period of time; and
scheduling the at least one task of the second service to be executed by the processing unit within the first period of time.

14. The device of claim 13, wherein determining the first period of time comprises:
determining a completion time of a first task of the first service based on the instant execution information;
determining a predicted start time of a second task of the first service based on a requirement on quality of service for the first service, the second task to be executed following the first task; and
determining the first period of time based on the completion time and the predicted start time.

15. A computer program product being tangibly stored in a computer storage medium and comprising computer-executable instructions, the computer-executable instructions, when executed by a device, causing the device to perform acts comprising:
determining, at least based on instant execution information of a task of a first service, a first period of time for the processing unit during which the processing unit suspends execution of tasks of the first service;
selecting, at least based on predicted execution durations of tasks of a second service, at least one task of the second service that can be completed within the first period of time; and
scheduling the at least one task of the second service to be executed by the processing unit within the first period of time.
